(19) United States
(12) Patent Application Publication
(10) Pub. No.: US 2011/0239211 A1
(43) Pub. Date: Sep. 29, 2011

(54) SYSTEM, APPARATUS, AND METHOD FOR DOWNLOADING FIRMWARE

(75) Inventors: Hwan Joon KIM, Seoul (KR); Weon Il Jin, Suwon-si (KR); Eun Ah Kim, Seoul (KR)

(73) Assignee: SAMSUNG ELECTRONICS CO., LTD., Suwon-si (KR)

(21) Appl. No.: 12/912,689

(22) Filed: Oct. 26, 2010

(30) Foreign Application Priority Data
Mar. 26, 2010 (KR) 10-2010-0027364

(51) Int. Cl. G06F 9/445; H04L 9/00

(52) U.S. Cl. 717/178; 713/150

(57) ABSTRACT

Disclosed are an apparatus for downloading a firmware and an apparatus for installing the firmware. The apparatus for downloading the firmware may download an encrypted firmware in the apparatus for installing the firmware. The apparatus for installing apparatus may receive and install the encrypted firmware.

The apparatus for downloading the firmware may encrypt the firmware using a user group key, and transmit the encrypted firmware to the apparatus for installing the firmware. The apparatus for installing the firmware may decrypt the encrypted firmware using the user group key, and install the decrypted firmware.

### CROSS-REFERENCE TO RELATED APPLICATION(S)

This application claims the benefit under 35 U.S.C. §119(a) of Korean Patent Application No. 10-2010-0027364, filed on Mar. 26, 2010, in the Korean Intellectual Property Office, the entire disclosure of which is incorporated herein by reference for all purposes.

### BACKGROUND

1. Field

The following description relates to a technique that may securely download and install a firmware.

2. Description of Related Art

Currently, examples in which personal or public businesses are conducted using various terminals, such as a cellular phone, a personal digital assistant (PDA), and the like, are gradually increasing. Also, examples in which personal financial information, such as banking, securities trading, and the like, use various terminals are increasing. Accordingly, security for the terminals becomes very important.

However, hacking performed on the terminals is also increasing. Hacking includes physical or electronic tampering, theft of private information, and illegally accessing the terminals. Recently, firmware hacked through Internet are circulated, and users illegally install the hacked firmware in their terminals. Since these illegal firmware are installed in the terminal to be used, security, such as that needed during a transaction using the terminal, may not be ensured.

Thus, there is a desire for a technique that may install only firmware legally tested by manufacturers, and prevent an installation of hacked firmware to improve security.

### SUMMARY

In one general aspect, there is provided a system for downloading a firmware, the system comprising: an encryption unit configured to encrypt a firmware; and a downloading unit configured to download the encrypted firmware.

The system may further include that the encryption unit is further configured to encrypt the firmware using a firmware encryption key (FEK).

The system may further include: an FEK generation unit configured to generate the FEK using an arbitrary random number; a user key selection unit configured to select at least one user key from among a plurality of user group keys; an FEK encryption unit to encrypt the FEK using the at least one user key; and a packaging unit configured to package information about the encrypted firmware, information about the encrypted FEK, and information about the at least one user key.

The system may further include that the information about the at least one user key comprises at least one of: an identifier (ID) of the at least one user key, an ID of the FEK, and a correlation between the at least one user key and the FEK.

The system may further include that the user key selection unit is further configured to select at least a second user key from among the plurality of user group keys, different from at least one user key, over time.

The system may further include: a time seed key generation unit configured to individually generate a time seed key with respect to a plurality of time intervals; a terminal seed key generation unit configured to generate a terminal seed key; and a user group key generation unit configured to generate the plurality of user group keys by combining the time seed key and a sum of the terminal seed keys.

The system may further include that: the downloading unit is further configured to download the encrypted firmware in an apparatus of installing the firmware; and the apparatus for installing the firmware is configured to: decrypt the encrypted firmware; and install, in a terminal, the firmware having been decrypted.

In another general aspect, there may be provided an apparatus for installing a firmware, the apparatus comprising: a reception unit configured to receive an encrypted firmware; a decryption unit configured to decrypt the encrypted firmware; and a firmware installation unit configured to install the decrypted firmware.

The apparatus may further include that the decryption unit decrypts the firmware using firmware encryption key (FEK) related to the firmware.

The apparatus may further include: a key induction unit, wherein the reception unit is further configured to receive information about an encrypted FEK related to the firmware and information about a user key related to the firmware, and wherein the key induction unit is further configured to: identify the user key using the information about the user key, and induce the FEK from the encrypted FEK using the user key.

The apparatus may further include the decryption unit is further configured to decrypt the firmware using a predetermined memory space on a virtual machine operating in a terminal.

In another general aspect, there is provided a method for downloading a firmware, the method comprising: encrypting the firmware; and downloading the encrypted firmware.

The method may further include that the encrypting encrypts the firmware using firmware encryption key (FEK).

The method may further include: generating the FEK using an arbitrary random number; selecting at least one user key from among a plurality of user group keys; encrypting the FEK using the at least one user key; and packaging information about the encrypted firmware, information about the encrypted FEK, and information about the at least one user key.

The method may further include: individually generating a time seed key with respect to a plurality of time intervals; generating a terminal seed key; and generating the plurality of user group keys by combining the time seed key and a sum of the terminal seed keys, wherein the selecting selects the at least one user key different from each other for each of the time intervals.

In another general aspect, there is provided a method for installing a firmware, the method comprising: receiving an encrypted firmware; decrypting the encrypted firmware; and installing the decrypted firmware.

The method may further include that the decrypting decrypts the firmware using firmware encryption key (FEK) related to the firmware.

The method may further include: receiving information about an encrypted FEK related to the firmware and information about a user key related to the firmware; and inducing the user key related to the firmware from the information about the user key, wherein the decrypting decrypts the encrypted FEK using the user key.

A non-transitory computer-readable medium may comprise a program for instructing a computer to perform the methods.

Other features and aspects may be apparent from the following detailed description, the drawings, and the claims.

### BRIEF DESCRIPTION OF THE DRAWINGS

FIG. 1 is a conceptual diagram illustrating an example of a terminal including a firmware installation apparatus implemented by hardware.

FIG. 2 is a conceptual diagram illustrating an example of a terminal including a firmware installation apparatus implemented by software.

FIG. 3 is a block diagram illustrating a structure of an example of an apparatus of downloading a firmware.

FIG. 4 is a block diagram illustrating a structure of an example of an apparatus of downloading a firmware that generates a user group key.

FIG. 5 is a conceptual block diagram illustrating an example of a method of managing a user group key.

FIG. 6 is a block diagram illustrating a structure of an example of a firmware installation apparatus that installs a firmware.

FIG. 7 is a flowchart illustrating an example of a method of downloading a firmware.

FIG. 8 is a flowchart illustrating an example of a method of installing a firmware.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

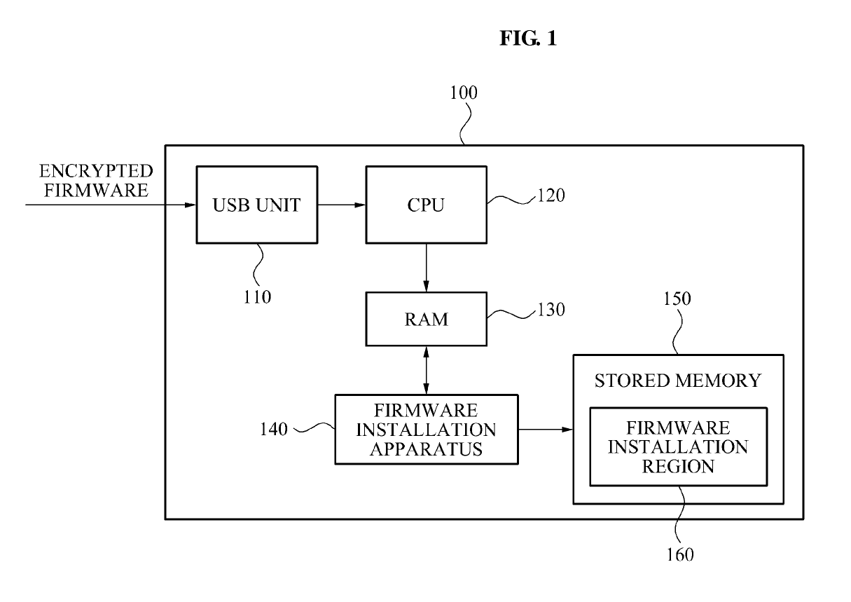

FIG. 1 is a conceptual diagram illustrating an example of a terminal 100 which may include a firmware installation apparatus implemented by hardware.

The terminal 100 may include a universal serial bus (USB) unit 110, a central processing unit (CPU) 120, a random access memory (RAM) 130, a firmware installation apparatus 140, and a storage memory 150. The storage memory 150 may include a firmware installation region 160. The firmware installation apparatus 140 may decrypt an encrypted firmware, and may install the decrypted firmware in the firmware installation region 160.

According to an embodiment, as a terminal in embodiments, electronics that may install a firmware and update the installed firmware, such as a cellular phone, a personal digital assistant (PDA), and the like, may be used.

According to an embodiment, the firmware may include at least one of: an operating system (OS) operated in the terminal, an application program performed in the OS, and data used by the application program.

The USB unit 110 may receive the encrypted firmware. In FIG. 1, the terminal 100 may receive the encrypted firmware using the USB unit 110. However, the terminal 100 may receive the encrypted firmware using other communication means that can communicate with an outside of the terminal 100. The encrypted firmware may not be installed in its original form in the firmware installation region 160, and a password of the encrypted firmware may need to be decrypted and then installed.

The firmware installation region 160 may be a region having a limited application from the storage memory of the terminal 100 to install the firmware, and may include a boot region.

The encrypted firmware may pass through the CPU 120, and may be stored in the RAM 130. The CPU 120 may not decrypt the encrypted firmware, and may store the encrypted firmware in its original form in the RAM 130.

The firmware installation apparatus 140 may authenticate whether the encrypted firmware stored in the RAM 130 is a secure firmware. In response to the encrypted firmware being the secure firmware, the firmware installation apparatus 140 may decrypt an encryption of the firmware, and may install the firmware in the firmware installation region 160.

According to an embodiment, the firmware installation apparatus 140 may be implemented by hardware or another processor separate from the CPU 120. Accordingly, the CPU 120 may not intervene or monitor a process of decrypting the encrypted firmware and a process of authenticating and installing the firmware. In one example, security in the process of decrypting and authenticating the encrypted firmware may be improved.

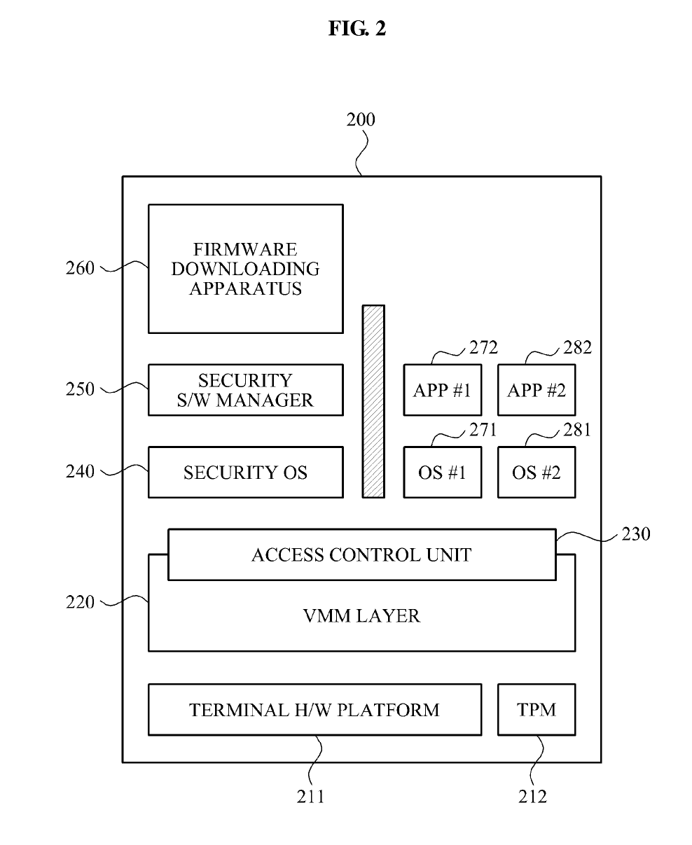

FIG. 2 is a conceptual diagram illustrating an example of a terminal 200 which may include a firmware installation apparatus implemented by software. The terminal 200 may include a terminal H/W platform 211, a trusted platform module (TPM) 212, a virtual machine manager (VMM) layer 220, and an access control unit 230. Also, in the terminal 200, at least one OSs 271 and 281 may be loaded, and at least one application programs 272 and 282 performed in each OS may be loaded.

For example, to hack the terminal 200, hackers may perform a hacking on the terminal 200 by performing, e.g., in the OSs 271 and 281, a program of monitoring a state of the terminal 200 or a program of performing a particular control. In response to the firmware installation apparatus 260 implemented by the software being performed in the general OS 271 and 281, this may be a target to be hacked by the hackers. In one example, the decryption of the encrypted firmware and the authentication and installation of the firmware may be exposed to the hackers.

In FIG. 2, the firmware installation apparatus 260 may be performed in a security OS 240 and a security software (S/W) manager 250, separate from the general OSs 271 and 281. The security OS 240 may be an OS having an enhanced security, different from the general OSs 271 and 281.

By a control of the access control unit 230, a memory space that each of the OSs 240, 271, and 281 accesses may be strictly separated. Thus, in response to the general OSs 271 and 281 being hacked by hackers, the hackers may not access the security OS 240 in which the firmware installation apparatus 260 is performed or the memory space that the security OS 240 accesses.

Thus, the decryption of the encrypted firmware and the authentication and installation of the firmware may be more securely protected.

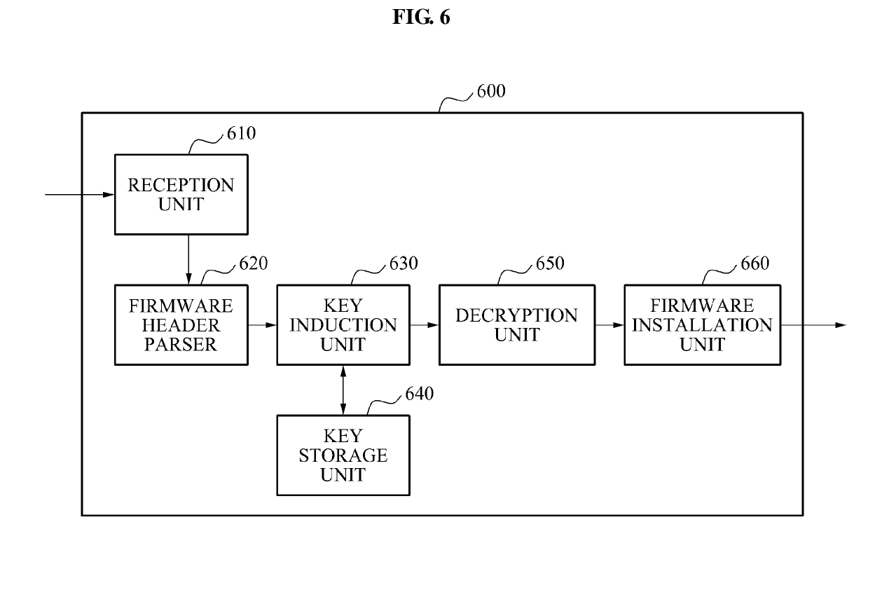

A detailed configuration of the firmware installation apparatus implemented by hardware or software will be described later with reference to FIG. 6.

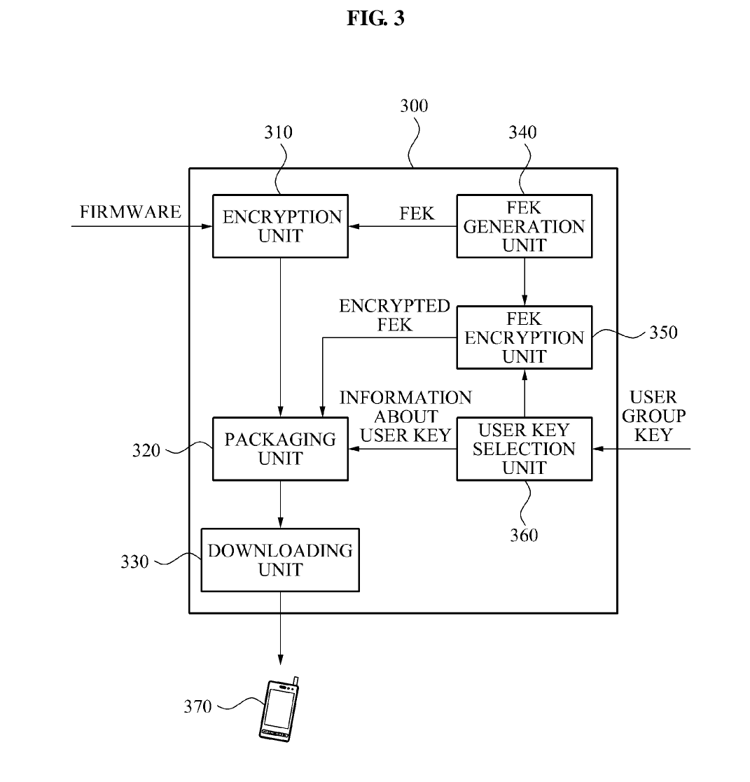

FIG. 3 is a block diagram illustrating a structure of an example of an apparatus for downloading a firmware 300.

The apparatus 300 may encrypt a firmware, and may download the encrypted firmware in a firmware installation apparatus. The firmware installation apparatus may be loaded in a terminal 370, and the firmware may be installed in a predetermined memory space of the terminal 370.

The apparatus 300 may include an encryption unit 310, a firmware encryption key (FEK) generation unit 340, an FEK encryption unit 350, a user key selection unit 360, a packaging unit 320, and a downloading unit 330.

The FEK generation unit 340 may generate an FEK. According to an embodiment, the FEK generation unit 340 may generate an arbitrary random number, and may generate the FEK using the generated random number.

The encryption unit 310 may encrypt the firmware. According to an embodiment, the encryption unit 310 may encrypt the firmware using the FEK. The firmware installation apparatus loaded in the terminal 370 may decrypt the encrypted firmware based on the FEK, and may install the decrypted firmware.

A technique for encrypting a particular file, data, and the like, using an encryption key may be well understood, and thus further descriptions of an example of encrypting the firmware using the FEK may be omitted.

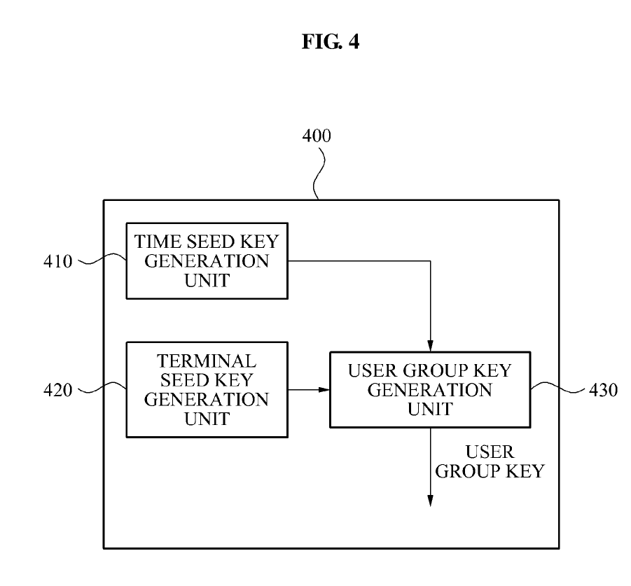

A plurality of user group keys may be assigned to the firmware installation apparatus. The user key selection unit 360 may select at least one user key from the plurality of user group keys. An example of selecting the user key by the user key selection unit 360 will be described with reference to FIG. 4.

The FEK encryption unit 350 may encrypt the FEK using the selected user key.

The packaging unit 320 may package information about the encrypted firmware, information about the encrypted FEK, and information about the user key. According to an embodiment, the information about the user key may include an identification (ID) of the user key or an ID of the FEK. Also, the information about the user key may include information about correlation between the user key and the FEK.

The downloading unit 330 may download the encrypted firmware in the firmware installation apparatus. According to an embodiment, the downloading unit 330 may download, in the firmware installation apparatus, the encrypted firmware packaged together with the encrypted FEK and the user key. The firmware installation apparatus loaded in the terminal 370 may decrypt the encrypted firmware using the user key and the encrypted FEK, and may install the decrypted firmware in the terminal 370.

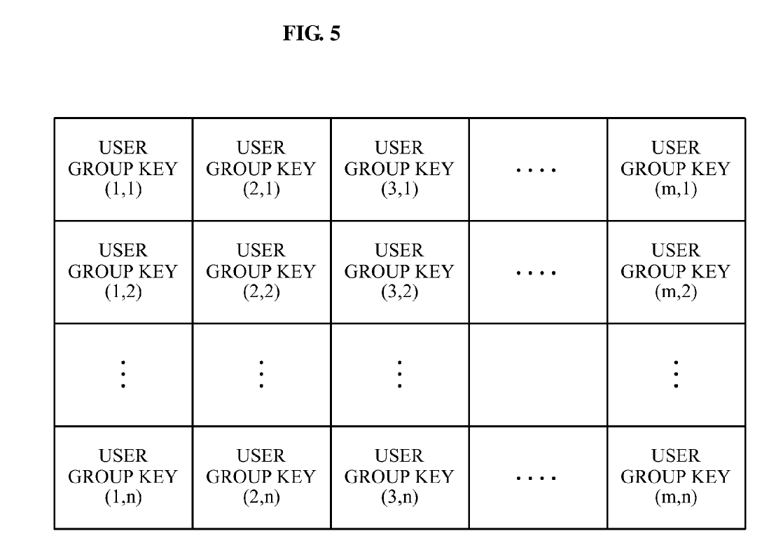

According to an embodiment, the user key selection unit 360 may select the user keys different from each other over time. A concept in which the user key selection unit 360 selects the user key will be described later with reference to FIG. 5.

FIG. 4 is a block diagram illustrating a structure of an example of an apparatus 300 of downloading a firmware that generates a user group key. The apparatus 300 may further include a time seed generation unit 410 and a terminal seed key generation unit 420, as well as the components of FIG. 3.

The time seed key generation unit 410 may individually generate a time seed key with respect to a plurality of time intervals. According to an embodiment, each of the plurality of time intervals may be a week or one month. The time seed key generated by the time seed key generation unit 410 with respect to a j^{th} time interval may be hereinafter referred to as “pSeed(j) (j=1, 2, . . . , m)”.

The terminal seed key generation unit 420 may generate a unique terminal seed key with respect to the firmware installation apparatus loaded in the terminal 370. A terminal seed key generated by the terminal seed key generation unit 420 with respect to the firmware installation apparatus loaded in an i^{th} terminal 370 may be hereinafter referred to as “uSeed(i) (i=1, 2, . . . , n)”.

The user group key generation unit 430 may generate user group keys by combining a sum of the respective terminal seed keys and the time seed key.

According to an embodiment, the user group key generation unit 430 may generate a group seed key for each terminal group including the firmware installation apparatus loaded in the terminal 370. The user group key generation unit 430 may generate the user group key by combining the group seed key and the time seed key. The user group key generation unit 430 may further generate the group seed key according to the following Equation 1.

gSeed(k)=Hash({sum of uSeed(i)}) [Equation 1]

In Equation 1, gSeed(k) denotes a group seed key for a k^{th} terminal group, uSeed(i) denotes a terminal seed key of the firmware installation apparatus that is loaded in an i^{th} terminal included in the k^{th} terminal group, and Hash( ) denotes a hash function. For example, the user group key generation unit 430 may obtain a value of the group seed key for the terminal group by inputting, in the hash function, a sum of terminal seed keys of the firmware installation apparatuses that are respectively loaded in all terminals included in each terminal group. The terminal group may include at least one firmware installation apparatus.

According to an embodiment, the user group key generation unit 430 may generate the user group key by inputting, in the hash function, a combination of the group seed key gSeed(k) and the time seed key pSeed(i) according to the following Equation 2.

UGK(i,j)=Hash(gSeed(k)+pSeed(i)) [Equation 2]

In Equation 2, a plurality of user group keys for a particular firmware installation apparatus may be generated. UGK(i,j) denotes a user group key for an i^{th} terminal group at a j^{th} time interval. In one example, the user group key generation unit 430 may select an appropriate user key from the plurality of user group keys based on a trusted key. According to an embodiment, the user group key generation unit 430 may store a trusted key list.

FIG. 5 is a conceptual block diagram illustrating an example of a method of managing a user group key.

The user group key generation unit 430 may select at least one user key from a plurality of user group keys illustrated in FIG. 5 to encrypt a firmware encryption key (FEK).

Each row of the user group key chart in FIG. 5 may represent a time interval. For example, a first column may denote a user group key used for a first time interval, and a second column may denote a user group key used for a second time interval. For example, each time interval may be a week or a month. Other time intervals may be used. In one example, a combination of user group keys used by the firmware downloading apparatus and or the firmware installation apparatus may be changed over time.

Each column of the user group key chart in FIG. 5 may represent a terminal group. For example, a first terminal group may use a user group key of a first row, and a second terminal group may use a user group key of a second row. In one example, the firmware downloading apparatus may store all user group keys illustrated in FIG. 5, and each terminal group may store only the user group key used by each terminal group.

According to another embodiment, the first terminal group may use the user group key of the first row, and the second terminal group may use the user group keys of the first row and the second row.

Each terminal group may include at least one firmware installation apparatus. A particular firmware installation apparatus may correspond to a particular terminal. A number of the firmware installation apparatuses included in each terminal group may differ from each other. For example, the first terminal group may include a single firmware installation apparatus, however, the second terminal group may include hundred or thousands of the firmware installation apparatuses.

As illustrated in FIG. 5, each user group key may be disused or reused in accordance with each time interval. The user group key related to encryption of a particular firmware may be identified by the information about the user group key that is packaged together with the encrypted firmware. Accordingly, a probability in which the information about the user group key is exposed to hackers may be reduced, and an exposed user group key may be temporarily used, and thus a probability in which the firmware installation apparatus is hacked by the hackers may be significantly reduced.

FIG. 6 is a block diagram illustrating a structure of an example of a firmware installation apparatus 600 that may install a firmware. The firmware installation apparatus 600 may include a reception unit 610, a firmware header parser 620, a key induction unit 630, a key storage unit 640, a decryption unit 650, and a firmware installation unit 660.

The firmware installation apparatus 600 may be installed in a terminal such as a cellular phone, a PDA, and the like. The firmware installation apparatus 600 may be implemented by hardware or software as illustrated in FIGS. 1 and 2.

The reception unit 610 may receive an encrypted firmware. According to an embodiment, the reception unit 610 may receive the encrypted firmware from the firmware downloading apparatus. In one embodiment, the reception unit 610 may receive the information about the encrypted FEK and the information about the user key which be packaged together with the encrypted firmware. The information about the user key may include information about correlation between the user key and the FEK.

In response to the reception unit 610 receiving the packaged firmware, the firmware header parser 620 may separate the information about the encrypted firmware, the information about the encrypted FEK, and the information about the user key, respectively, from the packaged firmware.

The key induction unit 630 may identify the user key using the information about the user key. The key induction unit 630 may decrypt the encrypted FEK using the identified user key. For example, the key induction unit 630 may induce the FEK from the encrypted FEK using the user key.

According to an embodiment, the key storage unit 640 may store at least one user group key. The information about the user key may include an ID of the user key. The user key induction unit 630 may identify the user key stored in the key storage unit 640, using the ID of the user key. The key storage unit 640 may store user group keys of a particular row from the user group keys, e.g., the rows illustrated in FIG. 5.

The decryption unit 650 may decrypt the encrypted firmware. According to an embodiment, the decryption unit 650 may decrypt the firmware using the FEK.

The firmware installation unit 660 may install the decrypted firmware. According to an embodiment, the firmware installation unit 660 may install the firmware by copying the decrypted firmware in a predetermined memory region. In one embodiment, the predetermined memory region may include a boot region of the terminal in which a firmware installation apparatus is loaded.

When the firmware installation apparatus 600 of FIG. 6 is implemented by the software, the decryption unit 650 may decrypt the encrypted firmware using a predetermined memory space of the terminal. In one example, the predetermined memory space may be a memory space of an imaginary machine, and may be a memory space which other OSs or other applications do not access. Accordingly, the predetermined memory space may be secure from invasion of hackers to prevent terminal hacking.

Also, the firmware installation apparatus 600 of FIG. 6 may be implemented by a single chip. In one example, the decryption unit 650 may decrypt the encrypted firmware using a memory space within the chip. In general, although hackers may access a main memory space of a terminal, however, they may not access a memory space of a particular chip. Accordingly, the terminal may be more secure from the invasion of hackers.

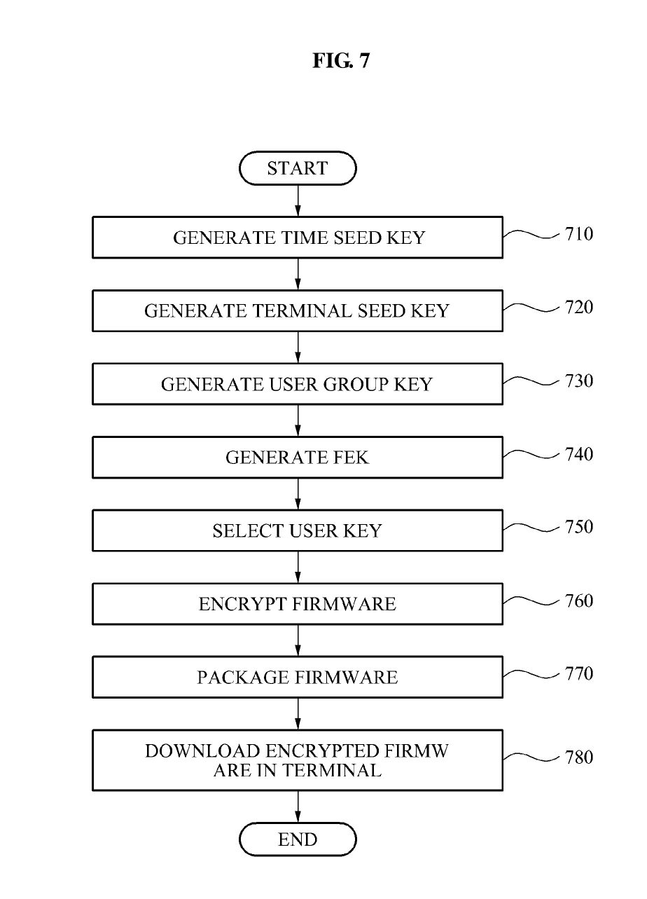

FIG. 7 is a flowchart illustrating an example of a method of downloading a firmware.

In operation 710, the firmware downloading apparatus may individually generate a time seed key with respect to each of a plurality of time intervals. According to an embodiment, the firmware downloading apparatus may generate the time seed keys different from each other for each time interval.

In operation 720, the firmware downloading apparatus may generate a unique terminal seed key with respect to each of a plurality of firmware installation apparatuses. According to an embodiment, the firmware downloading apparatus may generate a terminal seed key with respect to a plurality of firmware installation apparatuses included in a terminal group. A terminal seed key generated by the firmware downloading apparatus with respect to a firmware installation apparatus. The firmware installation apparatus may be loaded in an i^{th} terminal of a k^{th} terminal group may be hereinafter referred to as uSeed(i).

In operation 730, the firmware downloading apparatus may generate a user group key. The user group key may be generated by combining a sum of the terminal seed keys and the time seed key. According to an embodiment, the firmware downloading apparatus may generate a group seed key according to the following Equation 3.

gSeed(k)=Hash({sum of uSeed(i)}) [Equation 3]

In Equation 3, gSeed(k) denotes a group seed key for a k^{th} terminal group, uSeed(i) denotes a terminal seed key of a firmware installation apparatus that is loaded in an i^{th} terminal included in a k^{th} terminal group, and Hash( ) denotes a hash function. For example, the firmware downloading apparatus may obtain a value of the group seed key for the terminal group by inputting, in the hash function, a sum of terminal seed keys of all firmware installation apparatuses included in each terminal group. The terminal group may include at least one firmware installation apparatus.

According to an embodiment, the firmware downloading apparatus may generate the user group key by inputting, in the hash function, a combination of the group seed key gSeed(k) and the time seed key pSeed(i), according to the following Equation 4.

UGK(i,j)=Hash(gSeed(k)+pSeed(i)) [Equation 4]

In Equation 5, a plurality of user group keys may be generated with respect to a particular firmware installation apparatus. UGK(i,j) denotes a user group key for an i^{th} terminal group at a j^{th} time interval.

In operation 740, the firmware downloading apparatus may generate an FEK using an arbitrary random number.

In operation 750, the firmware downloading apparatus may select at least one user key from the plurality of user group keys. According to an embodiment, the firmware downloading apparatus may select the at least one user keys different from each other in accordance with a time interval determined in the firmware installation apparatus.

For example, the firmware downloading apparatus may select a first user key for a time interval of January, and select a second user key for a time interval of February. In one example, even if the first user key is hacked by a hacker, the hacker may hack the firmware installation apparatus only for January. Since the second user key is applied for February, the hacker may need to hack again the firmware installation apparatus. As a result, security of the firmware installation apparatus may be more maximally maintained.

In operation 760, the firmware downloading apparatus may encrypt the firmware using the FEK. The encrypted firmware may be decrypted using the FEK. The firmware installation apparatus may receive, from the firmware downloading apparatus, the encrypted firmware and the FEK. The firmware installation apparatus may then decrypt the encrypted firmware. The firmware installation apparatus may install the decrypted firmware in a terminal.

In operation 760, the firmware downloading apparatus may encrypt the FEK using the user key. The firmware installation apparatus may receive the user key from the firmware downloading apparatus, and may decrypt the FEK using the user key.

The firmware downloading apparatus may generate information about the user key. The information about the user key may include an ID of the user key or correlation between the user key and the FEK.

In operation 770, the firmware downloading apparatus may package information about the encrypted firmware, information about the encrypted FEK, and the information about the user key.

Also, the firmware downloading apparatus may download, in the firmware installation apparatus, the encrypted firmware packaged together with the information about the encrypted FEK and the information about the user key.

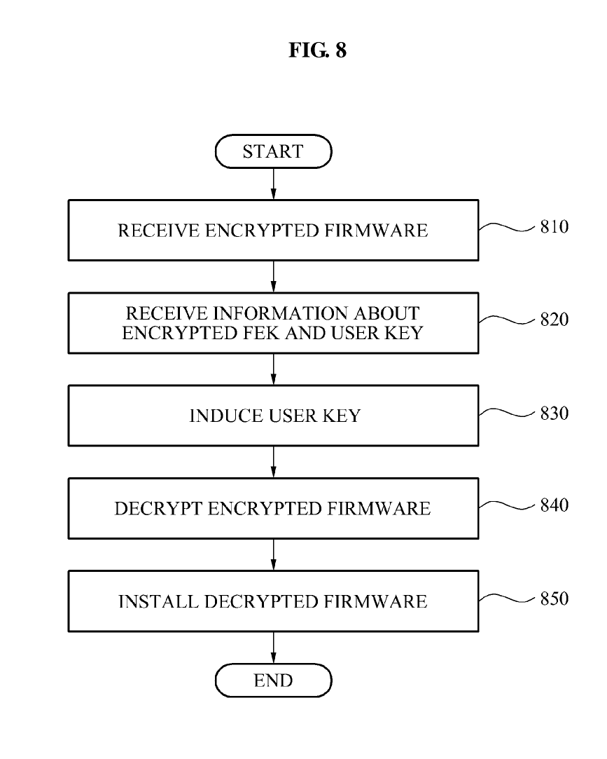

FIG. 8 is a flowchart illustrating an example of a method of installing a firmware.

In operation 810, the firmware installation apparatus may receive an encrypted firmware from the firmware downloading apparatus.

In operation 820, the firmware installation apparatus may receive, from the firmware downloading apparatus, an encrypted FEK and a user key related to the encrypted firmware. Information about the user key may include an ID of the user key or information about correlation between the user key and the FEK. According to an embodiment, a firmware receiver may receive information about an encrypted FEK packaged together with the encrypted firmware and the information about the user key related to the encrypted firmware.

In operation 830, the firmware installation apparatus may induce, from the encrypted FEK, an FEK related to the firmware using the information about the user key. For example, the information about the user key may include an ID of the user key and information about correlation between the user key and the FEK. The firmware installation apparatus may identify the user key using the ID of the user key. The firmware installation apparatus may then decrypt, from the encrypted FEK, the FEK based on the information about correlation between the user key and the FEK.

In operation 840, the firmware installation apparatus may decrypt the encrypted firmware.

According to an embodiment, the firmware installation apparatus may decrypt the firmware using the FEK related to the encrypted firmware.

In general, hackers may attempt to hack a terminal by accessing a memory of the terminal. The firmware installation apparatus may be loaded in the terminal as a software type or a hardware type. In one example, a memory space used by the firmware installation apparatus may be strictly separated from a memory space to which hackers may gain access. For example, the hackers may not access the memory space used by the firmware installation apparatus. Thus, the hackers may not monitor or hack encryption/decryption algorithms of the firmware installation apparatus, improving security of the terminal.

In operation 850, the firmware installation apparatus may install the decrypted firmware. According to an embodiment, the firmware installation apparatus may install the firmware by copying the decrypted firmware in a predetermined memory area.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for downloading a firmware, the system comprising:
an encryption unit configured to encrypt a firmware; and
a downloading unit configured to download the encrypted firmware.

2. The system of claim 1, wherein the encryption unit is further configured to encrypt the firmware using a firmware encryption key (FEK).

3. The system of claim 2, further comprising:
an FEK generation unit configured to generate the FEK using an arbitrary random number;
a user key selection unit configured to select at least one user key from among a plurality of user group keys;
an FEK encryption unit to encrypt the FEK using the at least one user key; and
a packaging unit configured to package information about the encrypted firmware, information about the encrypted FEK, and information about the at least one user key.

4. The system of claim 3, wherein the information about the at least one user key comprises at least one of: an identifier (ID) of the at least one user key, an ID of the FEK, and a correlation between the at least one user key and the FEK.

5. The system of claim 3, wherein the user key selection unit is further configured to select at least a second user key from among the plurality of user group keys, different from at least one user key, over time.

6. The system of claim 3, further comprising:
a time seed key generation unit configured to individually generate a time seed key with respect to a plurality of time intervals;
a terminal seed key generation unit configured to generate a terminal seed key; and
a user group key generation unit configured to generate the plurality of user group keys by combining the time seed key and a sum of the terminal seed keys.

7. The system of claim 1, wherein:
the downloading unit is further configured to download the encrypted firmware in an apparatus of installing the firmware; and
the apparatus for installing the firmware is configured to:
decrypt the encrypted firmware; and
install, in a terminal, the firmware having been decrypted.

8. An apparatus for installing a firmware, the apparatus comprising:
a reception unit configured to receive an encrypted firmware;
a decryption unit configured to decrypt the encrypted firmware; and
a firmware installation unit configured to install the decrypted firmware.

9. The apparatus of claim 8, wherein the decryption unit decrypts the firmware using firmware encryption key (FEK) related to the firmware.

10. The apparatus of claim 8, further comprising:
a key induction unit,
wherein the reception unit is further configured to receive information about an encrypted FEK related to the firmware and information about a user key related to the firmware, and
wherein the key induction unit is further configured to:
identify the user key using the information about the user key, and
induce the FEK from the encrypted FEK using the user key.

11. The apparatus of claim 8, wherein the decryption unit is further configured to decrypt the firmware using a predetermined memory space on a virtual machine operating in a terminal.

12. A method for downloading a firmware, the method comprising:
encrypting the firmware; and
downloading the encrypted firmware.

13. The method of claim 12, wherein the encrypting encrypts the firmware using firmware encryption key (FEK).

14. The method of claim 13, further comprising:
generating the FEK using an arbitrary random number;
selecting at least one user key from among a plurality of user group keys;
encrypting the FEK using the at least one user key; and
packaging information about the encrypted firmware, information about the encrypted FEK, and information about the at least one user key.

15. The method of claim 14, further comprising:
individually generating a time seed key with respect to a plurality of time intervals;
generating a terminal seed key; and
generating the plurality of user group keys by combining the time seed key and a sum of the terminal seed keys,
wherein the selecting selects the at least one user key different from each other for each of the time intervals.

16. A method for installing a firmware, the method comprising:
receiving an encrypted firmware;
decrypting the encrypted firmware; and
installing the decrypted firmware.

17. The method of claim 16, wherein the decrypting decrypts the firmware using firmware encryption key (FEK) related to the firmware.

18. The method of claim 17, further comprising:
receiving information about an encrypted FEK related to the firmware and information about a user key related to the firmware; and
inducing the user key related to the firmware from the information about the user key,
wherein the decrypting decrypts the encrypted FEK using the user key.

19. A non-transitory computer-readable medium comprising a program for instructing a computer to perform the method of claim 12.

20. A non-transitory computer-readable medium comprising a program for instructing a computer to perform the method of claim 16.
